(19) United States
(12) Patent Application Publication
(10) Pub. No.: US 2016/0114222 A1
(43) Pub. Date: Apr. 28, 2016

(54) METHOD OF MAKING A GOLF BALL WITH COMPOSITE CONSTRUCTION

(71) Applicant: Acushnet Company, Fairhaven, MA (US)

(72) Inventor: Stephen K. Scolamiero, Fairhaven, MA (US)

(21) Appl. No.: 14/523,534

(22) Filed: Oct. 24, 2014

(51) Int. Cl. A63B 45/00; A63B 37/00

(52) U.S. Cl. CPC A63B 45/00; A63B 37/0092; B33Y 10/00

(57) ABSTRACT

A method and system is described for making a golf ball. The method comprises providing at least two or more dissimilar materials. Next, the at least two or more dissimilar materials are applied onto a substrate to provide one or more heterogeneous preforms. The one or more heterogeneous preforms are then formed into a golf ball component.

### FIELD OF THE INVENTION

The invention is directed to a method and system for making a golf ball using at least two or more dissimilar materials.

### BACKGROUND OF THE INVENTION

Solid golf balls include one-piece balls, which are easy to construct and relatively inexpensive, but have poor playing characteristics and are thus generally limited for use as range balls. Two-piece solid balls are constructed with a solid, thermoset core and a thermoplastic cover and are generally the most popular with recreational golfers because they are very durable and provide maximum distance. Multi-layer balls are generally formed of one or more core layers covered by one or more cover layers. These balls, while more expensive to manufacture, offer more flexibility in the design to create better performance characteristics.

Balls having a two-piece or multi-layer constructions are commonly formed of a polymeric core encased by a cover. Typically, the core is formed from polybutadiene that is chemically cross-linked with zinc diacrylate and/or other similar crosslinking agents. These balls are generally covered by an ionomeric cover or an ionomeric inner cover and a polyurethane outer cover. The multi-layer balls are regarded as having an extended range of playing characteristics. A variety of golf balls that are designed to provide a wide range of playing characteristics, i.e., the compression, velocity, “feel,” and spin, are known in the prior art. However, there remains a need for customized golf balls having a variety of playing characteristics to match a golfer that are not limited to layered constructions of homogeneous material.

### BRIEF SUMMARY OF THE INVENTION

The invention is directed to a method and system for making a golf ball. The method comprises providing at least two or more dissimilar materials. Next, the at least two or more dissimilar materials are applied onto a substrate to provide one or more heterogeneous preforms. The one or more heterogeneous preforms are then formed into a golf ball component.

In another embodiment, a method of making a golf ball is provided. The method comprises providing at least two or more dissimilar materials. Next, the dissimilar materials are disposed into cavities to form heterogeneous preform shells. The heterogeneous preform shells are then formed over a golf ball core to form a heterogeneous intermediate layer or cover.

In another embodiment, a method of making a golf ball is provided. The method comprises providing at least two or more dissimilar materials. The two or more dissimilar materials are the applied into one or more cover layers to provide one or more cover heterogeneous performance regions. The one or more cover heterogeneous performance regions are then formed into the golf ball component. The one or more cover layers define cavities for receipt of the two or more dissimilar materials and the dissimilar materials are injected into the cavities using a plurality of injection heads to form the one or more cover heterogeneous performance regions.

In one embodiment, the two or more dissimilar materials comprise polybutadiene and zinc diacrylate adjusted to provide soft and hard areas within the heterogeneous preform and the preform is cured into a golf ball core or golf ball core center. For example, the zinc diacrylate is present in an amount between 10-25 parts per hundred of polybutadiene to provide a softer area within the one or more heterogeneous preform and in an amount between 26-40 parts per hundred of polybutadiene to provide a harder area within the one or more heterogeneous preform.

In another embodiment, the two or more dissimilar materials comprises two or more polymers or thermoplastic polymers with dissimilar hardness adjacent to one another to provide soft and hard areas within the heterogeneous preform. In one embodiment, the two or more dissimilar materials comprise thermoplastic materials having flexural moduli that differ by at least 20,000 psi. In another embodiment, the two or more dissimilar materials comprise thermoplastic materials having material hardnesses that differ by at least 5 Shore D.

In one embodiment, the two or more dissimilar materials comprises thermoplastic, thermoset materials, or combinations thereof having carboxylic acid less than 12% to provide a softer area within the one or more heterogeneous preforms.

In one embodiment, the wherein the two or more dissimilar materials comprises thermoplastic, thermoset materials, or combinations thereof having carboxylic acid greater than 19% to provide a harder area within the one or more heterogeneous preforms.

In one embodiment, the two or more dissimilar materials comprises Surlyn® 7940 in the range of 30-50%, Surlyn® 8940 in the range of 30-50%, and 10-40% of Surlyn® 8320 or Fusabond® to provide a softer area within the one or more heterogeneous preforms.

In one embodiment, the two or more dissimilar materials comprises Surlyn® 8150 in the range of 30-50% and Surlyn® 9150 in the range of 30-50% to provide a harder area within the one or more heterogeneous preforms.

In one embodiment, the applying of at least two or more materials uses stereolithography. In another embodiment, the applying of at least two or more dissimilar materials uses a computer-controlled robot. In a further embodiment, the applying of at least two or more dissimilar materials uses a plurality of controlled dispensing nozzles. In an even further embodiment, the applying of at least two or more dissimilar materials uses a plurality of 3-D printer nozzles.

In one embodiment, the two or more dissimilar materials are applied onto a substrate in a form selected from a group consisting: a fluid state, layers, shapes, and combinations thereof.

In one embodiment, the substrate is cavities for receipt of the two or more dissimilar materials and the dissimilar materials are injected into the cavities using a plurality of injection heads to form the one or more heterogeneous preforms.

The one or more cover performance regions are marked with one or more of the following to indicate harder material regions and softer material regions: different colors, indicia, and dimple sizes.

### BRIEF DESCRIPTION OF THE DRAWINGS

The novel features which are characteristic of the invention are set forth in the appended claims. However, the invention's preferred embodiments, together with further objects and attendant advantages, will be best understood by reference to the following detailed description taken in connection with the accompanying drawings in which:

FIG. 1 illustrates a hemispherical preform of a golf ball defining cavities configured for receipt of two or more dissimilar materials to provide one or more heterogeneous preforms;

FIG. 2 is a cross-sectional view of a hemispherical preform of a golf ball having two or more dissimilar materials in the preformed shape of bricks to provide one or more heterogeneous preforms; and

FIG. 3 is a cross-section of a cover of a golf ball, the cover defining a cavity filled with two or more dissimilar materials to provide one or more heterogeneous performance regions.

### DETAILED DESCRIPTION OF THE EMBODIMENTS

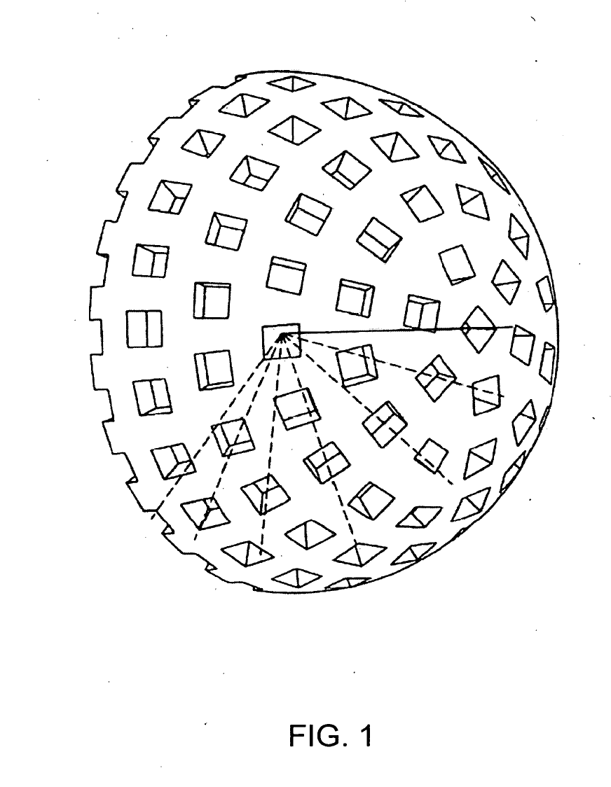

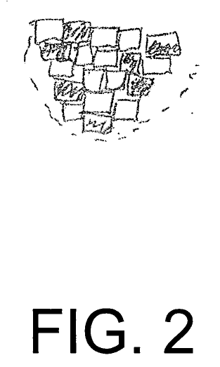

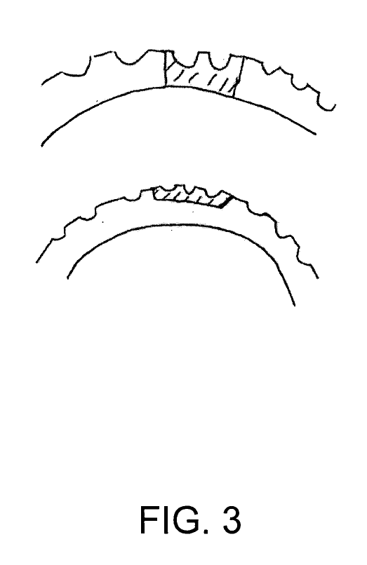

Referring generally to FIGS. 1-3, the invention is directed to a method or system for making a golf ball component with a composite construction. The method or system of making the golf ball component provides the opportunity to achieve unique physical properties based on the desired outcome of the golf ball designer or based on player needs. This invention gives the designer more tools to tune golf ball performance characteristics like feel, sound, spin, and COR. In addition, the invention allows for precisely applying and building adjoining heterogeneous performance regions or areas in any geometric shape or pattern with different physical properties within a golf ball component.

### Methods

The invention is directed to a method and system for making a golf ball component, such as a core, an intermediate layer and/or a cover of a golf ball. To start, the method comprises providing at least two or more dissimilar materials. The at least two or more dissimilar materials are applied onto a substrate in a specific manner or way to provide one or more heterogeneous preforms. The one or more heterogeneous preforms are then formed into the golf ball component.

In another embodiment, an alternative method is provided for making a golf ball component. Precisely and strategically placed dissimilar materials applied in specific patterns onto a substantially spherical center builds up spherical shell layer(s) to form a spherical core preform. In one embodiment, the application of the droplets or strips is provided progressively onto a spherical form. Positions of the applied materials within the layers and from one layer to the next form a specific 3D golf ball core structure once the spherical preform is cross-linked in a mold.

In another embodiment, an alternative method is provided for making a golf ball component. The method comprises providing a preform having one or more cavities. At least two or more dissimilar materials in the form of wrapped layers are applied within the one or more cavities to provide one or more heterogeneous performance regions. The one or more heterogeneous layers and the preform are then formed into a golf ball component.

In another embodiment, an alternative method is provided for making a golf ball component. A preform is provided having one or more cavities. At least two or more dissimilar materials in preformed shapes are applied within the one or more cavities to provide one or more heterogeneous layers. The preformed shapes may be crosslinked or not, and with or without a binding matrix. By way of example, and without limitation, the preformed shapes may be in the shape of a brick. Of course, other shapes and sizes are contemplated, such as squares, rectangles, circular, and others, which can be preformed shapes. The one or more heterogeneous layers and the preform are then formed into a golf ball component.

In another embodiment, an alternative method is provided for making a golf ball component. A preform is provided having one or more cavities. At least two or more dissimilar materials are applied within the one or more cavities using stereolithography to provide one or more heterogeneous preforms. The one or more heterogeneous preforms are then formed into a golf ball component.

In another embodiment, an alternative method is provided for making a golf ball component. Multiple computer controlled dispensing heads may each apply at two or more dissimilar or different materials that can build a composite golf ball component. In a further embodiment, the applying of at least two or more dissimilar materials uses a plurality of controlled dispensing nozzles. In an even further embodiment, the applying of at least two or more dissimilar materials uses a plurality of 3-D printer nozzles.

In another embodiment, an alternative method is provided for making a golf ball component. Multiple preformed elements (homogeneous or composites themselves) of at least two or more dissimilar materials can be assembled by a computer controlled robot or the in progress golf ball preform can be moved through multiple assembly stations each applying specific elements to complete the golf ball component.

In another embodiment, an alternative method of making a golf ball is provided. The method comprises providing at least two or more dissimilar materials. Next, the dissimilar materials are disposed into cavities to form heterogeneous preform shells. The heterogeneous preform shells are then formed over a golf ball core to form a heterogeneous intermediate layer or cover.

In another embodiment, an alternative method of making a golf ball is provided. The method comprises providing at least two or more dissimilar materials. The dissimilar materials are disposed into cavities. Two or more dissimilar materials are applied in the form of droplets and are injected into the one or more cavities to provide one or more heterogeneous preforms.

In another embodiment, an alternative method of making a golf ball is provided. The method comprises providing at least two or more dissimilar materials. The dissimilar materials are disposed into cavities. Two or more dissimilar materials are applied in the form of wrapped layers are applied within the one or more cavities to provide one or more heterogeneous preforms.

In another embodiment, an alternative method of making a golf ball is provided. The method comprises providing at least two or more dissimilar materials. The dissimilar materials are disposed into cavities. Two or more dissimilar materials are applied in the form of preformed shapes within the one or more cavities to provide one or more heterogeneous preforms.

In another embodiment, one or more cover layers are disposed about the golf ball component. At least two or more dissimilar materials are applied into the one or more cover layers to provide one or more cover heterogeneous performance regions. The one or more cover heterogeneous performance regions are then formed into the golf ball component.

In one embodiment, the one or more cover layers define one or more cavities. In one embodiment, the one or more cover layers defines cavities for receipt of the two or more dissimilar materials and the dissimilar materials are injected into the cavities using a plurality of injection heads to form the one or more cover heterogeneous performance regions. In one embodiment, the cavities are formed within the one or more cover layers by removing material from the one or more cover layers. For example, without limitation, the at least two or more dissimilar materials are injected in the form of droplets of less than 1 mm³ into the one or more cavities to provide one or more cover heterogeneous performance regions.

In another embodiment, one or more cover layers are disposed about the golf ball component. The one or more cover layers have one or more cavities. At least two or more dissimilar materials in the form of wrapped layers are applied within the one or more cavities to provide one or more cover heterogeneous performance regions.

In another embodiment, one or more cover layers are disposed about the golf ball component. The one or more cover layers have one or more cavities. At least two or more dissimilar materials in preformed shapes are applied within the one or more cavities to provide one or more cover heterogeneous performance regions.

In another embodiment, one or more cover layers are disposed about the golf ball component. The one or more cover layers have one or more cavities. At least two or more dissimilar materials are applied within the one or more cavities using stereolithography to provide one or more heterogeneous performance regions.

In another embodiment, one or more cover layers are disposed about the golf ball component. The one or more cover layers have one or more cavities. The one or more cavities may be formed in a cover layer by removing regions that can be post filled with at least two or more dissimilar materials using a variety of methods known in the art. At least two or more dissimilar materials are applied within the one or more cavities. The golf ball component is then finish molded in a compression molding, injection molding, or casting cavity.

Dissimilar Materials

In one embodiment, dissimilar materials are dissimilar polymer materials adjoining each other to form a composite. In another example of dissimilar materials, the same polymer materials may be used but having different physical properties adjoining each other. Another example of dissimilar materials are fibers adjoining polymers either in perform, in strands, tapes, or bare fibers.

In addition, the two or more dissimilar materials may comprise a rubber based compound comprising cis-1,4 polybutadiene rubber, a crosslinking agent comprising a metallic sale of unsaturated carboxylic acid in an amount between 10 to 50 parts per hundred of rubber; and a peroxide initiator. In one embodiment, the preform comprises a homogeneous composition throughout, preferably from uncured polybutadiene.

In one embodiment, the two or more dissimilar materials comprises polybutadiene, a crosslinking agent, and other materials adjusted to provide soft and hard areas within the heterogeneous layers. In one embodiment, the dissimilar materials comprises polybutadiene rubber, peroxide between 0.2-2 parts per hundred (pph), regrind between 0-30 pph, zinc oxide between 0-10 pph, peptizing agent between 0-2 pph, and processing aid between 0-2 pph.

Crosslinking agents are typically included to increase the hardness of the reaction product. The crosslinking agent must be present in an amount sufficient to crosslink a portion of the chains of polymers in the resilient polymer component. For example, the desired compression may be obtained by adjusting the amount of crosslinking. This may be achieved, for example, by altering the type and amount of crosslinking agent.

By way of example, without limitation, the crosslinking agent is ZDA or zinc diacrylate. In one embodiment, without limitation, the two or more dissimilar materials comprise polybutadiene and zinc diacrylate adjusted to provide soft and hard areas within the heterogeneous preform and the preform is cured into a golf ball core or golf ball core center. For example, the zinc diacrylate is present in an amount between 10-25 parts per hundred of polybutadiene, more preferably 15-23 parts per hundred, to provide a softer area within the one or more heterogeneous preform and in an amount between 26-40 parts per hundred of polybutadiene, more preferably 28-35 parts per hundred, to provide a harder area within the one or more heterogeneous preform.

Examples of the crosslinking agent include, but are not limited to, one or more metal salt diacrylates, dimethacrylates, and monomethacrylates, wherein the metal is magnesium, calcium, zinc, aluminum, sodium, lithium, or nickel. Preferred acrylates include zinc acrylate, zinc diacrylate, zinc methacrylate, zinc dimethacrylate, and mixtures thereof.

The initiator can also be any known polymerization initiator which decomposes during the cure cycle. Suitable initiators include organic peroxide compounds, such as dicumyl peroxide; 1,1-di(t-butylperoxy) 3,3,5-trimethyl cyclohexane; α,α-bis(t-butylperoxy)diisopropylbenzene; 2,5-dimethyl-2,5 di(t-butylperoxy) hexane; di-t-butyl peroxide; and mixtures thereof. Other examples include, but are not limited to, VAROX® 231XL and Varox® DCP-R, commercially available from Elf Atochem of Philadelphia, Pa.; PERKODOX® BC and PERKODOX® 14, commercially available from Akzo Nobel of Chicago, III.; and ELASTOCHEM® DCP-70, commercially available from Rhein Chemie of Trenton, N.J.

In one embodiment, the golf ball may comprise an organo sulfur compound selected from a group consisting of: ZnPCTP, DTDS, DPDS, and mixtures thereof. In some formulations, optionally additional organa sulfur compounds like ZnPCTP or DTDS or DPDS or related materials may be incorporated from 0.25 to 2.5 pphr to provide additional soft and resilient property.

In one embodiment, the golf ball may comprise one or more antioxidants. Typically, antioxidants are included in conventional rubber-based golf ball component compositions because antioxidants are included in the materials supplied by manufacturers of compounds used therein. Without being bound to any particular theory, higher amounts of antioxidant in the reaction product may result in less trans-isomer content because the antioxidants consume at least a portion of the free radical source. For example, a polybutadiene reaction product with 0.5 pphr of antioxidant cured at 335 degrees F. for 11 minutes results in about 15 percent trans-isomer content at an exterior surface of the center and about 13.4 percent at an interior location after the conversion reaction. In contrast, the same polybutadiene reaction product substantially free of antioxidants results in about 32 percent trans-isomer content at an exterior surface and about 21.4 percent at an interior location after the conversion reaction.

The two or more dissimilar materials may also include other suitable thermosetting compositions which include, but are not limited to, natural rubbers, polybutadienes, polyisoprenes, ethylene propylene rubbers (EPR), ethylene-propylene-diene rubbers (EPDM), styrene-butadiene rubbers, butyl rubbers, halobutyl rubbers, polyurethanes, polyureas, acrylonitrile butadiene rubbers, polychloroprenes, alkyl acrylate rubbers, chlorinated isoprene rubbers, acrylonitlile chlorinated isoprene rubbers, polyalkenamers, phenol formaldehydes, melamine formaldehydes, polyepoxides, polysiloxanes, polyesters, alkyds, polyisocyanurates, polycyanurates, polyacrylates, and combinations of two or more thereof.

Non-limiting examples of suitable commercially available thermosetting materials are Buna CB high-cis neodymium-catalyzed polybutadiene rubbers, such as Buna CB 23, and Buna CB high-cis cobalt-catalyzed polybutadiene rubbers, such as Buna CB 1220 and 1221, commercially available from Lanxess Corporation; SE BR-1220, commercially available from The Dow Chemical Company; Europrene® NEOCIS® BR 40 and BR 60, commercially available from Polimeri Europa® UBEPOL-BR® rubbers, commercially available from UBE Industries, Inc.; BR 01, commercially available from Japan Synthetic Rubber Co., Ltd.; Neodene high-cis neodymium-catalyzed polybutadiene rubbers, such as Neodene BR 40, commercially available from Karbochem; TP-301 transpolyisoprene, commercially available from Kuraray Co., Ltd.; Vestenamer® polyoctenamer, commercially available from Evonik Industries; Butyl 065 and Butyl 288 butyl rubbers, commercially available from ExxonMobil Chemical Company; Butyl 301 and Butyl 101-3, commercially available from Lanxess Corporation; Bromobutyl 2224 and Chlorobutyl 1066 halobutyl rubbers, commercially available from ExxonMobil Chemical Company; Bromobutyl X2 and Chlorobutyl 1240 halobutyl rubbers, commercially available from Lanxess Corporation; BromoButyl 2255 butyl rubber, commercially available from Japan Synthetic Rubber Co., Ltd.; Vistalon® 404 and Vistalon® 706 ethylene propylene rubbers, commercially available from ExxonMobil Chemical Company; Dutral CO 058 ethylene propylene rubber, commercially available from Polimeri Europa; Nordel® IP NDR 5565 and Nordel® IP 3670 ethylene-propylene-diene rubbers, commercially available from The Dow Chemical Company; EPTI045 and EPTI 045 ethylene-propylene-diene rubbers, commercially available from Mitsui Corporation; Buna SE 1721 TE styrene-butadiene rubbers, commercially available from Lanxess Corporation; Afpol 1500 and Afpol 552 styrene-butadiene rubbers, commercially available from Karbochem; Nipol® DN407 and Nipol® 1041L acrylonitrile butadiene rubbers, commercially available from Zeon Chemicals, L.P.; Neoprene GRT and Neoprene AD30 polychloroprene rubbers; Vamac® ethylene acrylic elastomers, commercially available from E. 1. du Pont de Nemours and Company; Hytemp® AR12 and AR214 alkyl acrylate rubbers, commercially available from Zeon Chemicals, L.P.; and Hypalon® chlorosulfonated polyethylene rubbers, commercially available from E. 1. du Pont de Nemours and Company.

In another embodiment, the two or more dissimilar materials comprises two or more polymers or thermoplastic polymers with dissimilar hardness adjacent to one another to provide soft and hard areas within the heterogeneous preform. In one embodiment, the two or more dissimilar materials comprise thermoplastic materials having flexural moduli that differ by at least 20,000 psi. In another embodiment, the two or more dissimilar materials comprise thermoplastic materials having material hardnesses that differ by at least 5 Shore D.

The two or more dissimilar materials comprises thermoplastic, thermoset materials, or combinations thereof. In one embodiment, the two or more dissimilar materials further comprises carboxylic acid less than 12% to provide a soft area within the one or more heterogeneous preforms. By way of example, the two or more dissimilar materials comprises thermoplastic, thermoset materials, or combinations thereof having carboxylic acid greater than 19% to provide a harder area within the one or more heterogeneous preforms.

More specifically, in one embodiment, the two or more dissimilar materials comprises Surlyn® 7940 in the range of 30-50%, Surlyn® 8940 in the range of 30-50%, and 10-40% of Surlyn® 8320 or Fusabond® to provide a soft area within the one or more heterogeneous preforms. In another embodiment, the two or more dissimilar materials comprises Surlyn® 8150 in the range of 30-50% and Surlyn® 9150 in the range of 30-50% to provide a hard area within the one or more heterogeneous preforms.

The two or more dissimilar materials of the intermediate layer may also include other suitable thermoplastic compositions which include, but are not limited to, suitable thermoplastic compositions include, but are not limited to, ionomers, non-ionomeric acid copolymers, polyesters, polyamides, polyether amides, polyester amides, polyimides, polyurethanes, polyureas, polystyrenes, polyethylenes, polypropylenes, rubber-toughened polyolefins, styrenic copolymers and styrenic block copolymers, dynamically vulcanized elastomers, ethylene vinyl acetates, ethylene (meth)acrylate based polymers, ethylene elastomers, propylene elastomers, copolymers of ethylene and propylene, polyvinyl chlorides, polytetrafluoroethylene (e.g., Teflon® polytetrafluoroethylene, commercially available from E.I. du Pont de Nemours and Company), functionalized derivatives thereof, and combinations of two or more thereof.

Non-limiting examples of suitable commercially available thermoplastics are Surlyn® ionomers and DuPont® HPF 1000 and HPF 2000 highly neutralized ionomers, commercially available from E.I. du Pont de Nemours and Company; Clarix® ionomers, commercially available from A. Schulman, Inc.; Iotek® ionomers, commercially available from ExxonMobil Chemical Company; Amplify® 10 ionomers, commercially available from The Dow Chemical Company; Amplify® GR functional polymers and Amplify® TY functional polymers, commercially available from The Dow Chemical Company; Fusabond® functionalized polymers, including ethylene vinyl acetates, polyethylenes, metallocene-catalyzed polyethylenes, ethylene propylene rubbers, and polypropylenes, commercially available from E.I. du Pont de Nemours and Company; Exxelor® maleic anhydride grafted polymers, including high density polyethylene, polypropylene, semi-crystalline ethylene copolymer, amorphous ethylene copolymer, commercially available from ExxonMobil Chemical Company; ExxonMobil® PP series polypropylene impact copolymers, such as PP7032E3, PP7032KN, PP7033E3, PP7684KN, commercially available from ExxonMobil Chemical Company; Vistamaxx® propylene-based elastomers, commercially available from ExxonMobil Chemical Company; Vistalon® EPDM rubbers, commercially available from ExxonMobil Chemical Company; Exact® plastomers, commercially available from ExxonMobil Chemical Company; Santoprene® thermoplastic vulcanized elastomers, commercially available from ExxonMobil Chemical Company; Nucrel® acid copolymers, commercially available from E.I. du Pont de Nemours and Company; Escor® acid copolymers, commercially available from ExxonMobil Chemical Company; Primacor® acid copolymers, commercially available from The Dow Chemical Company; Kraton® styrenic block copolymers, commercially available from Kraton Performance Polymers Inc.; Septon® styrenic block copolymers, commercially available from Kuraray Co., Ltd.; Lotader® ethylene acrylate based polymers, commercially available from Arkema Corporation; Polybond® grafted polyethylenes and polypropylenes, commercially available from Chemtura Corporation; Royaltuf® chemically modified EPDM, commercially available from Chemtura Corporation; Vestenamer® polyoctenamer, commercially available from Evonik Industries; Pebax® polyether and polyester amides, commercially available from Arkema Inc.; polyester-based thermoplastic elastomers, such as Hytrel® polyester elastomers, commercially available from E.I. du Pont de Nemours and Company, and Riteflex® polyester elastomers, commercially available from Ticona; Estane® thermoplastic polyurethanes, commercially available from The Lubrizol Corporation; Grivory® polyamides and Grilamid® polyamides, commercially available from EMS Grivory; Zytel® polyamide resins and Elvamide® nylon multipolymer resins, commercially available from E.I. du Pont de Nemours and Company; and Elvaloy® acrylate copolymer resins, commercially available from E.I. du Pont de Nemours and Company.

The two or more dissimilar materials of the cover layer may also include other suitable materials which include, but are not limited to, isocyanate, polyol, and a curing agent which shall be explained further below.

By way of example, without limitation, the two or more dissimilar materials of the cover layer comprises thermoplastic, thermoset materials, or combinations thereof. The one or more cover heterogeneous performance regions comprise one or more hard material areas and soft material areas.

### Applying

In another embodiment, the at least two or more dissimilar materials are applied in the form of a fluid state, in the form of wrapped layers, in the form of preformed shapes, or combinations or other variations thereof.

Specific application methods of polymer or dissimilar material can achieve added benefits including, but not limited to, circumferential molecular chain alignment that would yield greater tensile strength and higher COR than non-aligned materials, intentional voids within the spherical uncured preform will trap air once the mold is closed and this compressible gas should absorb the volume increase of the core materials in heating, this should yield flash less cores molded to size, and same or different polymers can be varied colors in specific patterns to be seen through a clear cover which indicates soft or hard areas.

### Substrate

In one embodiment, the substrate is cavities for receipt of the two or more dissimilar materials and the dissimilar materials are injected into the cavities using a plurality of injection heads to form the one or more heterogeneous preforms. For example, without limitation, the cavities by removing material using computer numerical control (CNC) milling. Optionally, the golf ball component can be made with or without the substrate.

The substrate is selected from a group consisting of: a base member, mold cavity, shaping cavity, curing cavity, and combinations thereof. In one embodiment, the base member may be a flat surface or plate used to support the building of layers upon one another.

Forming into Golf Ball

The one or more methods of the invention may be implemented in a variety of configurations. By way of example, and without limitation, the following are examples of making a golf ball using the methods above.

In one embodiment, an FEA (finite element analysis) based core structural design will help determine intentional placement of regions of differing physical properties within the core, intermediate layer, and/or cover. Once a design is complete there are numerous devices and techniques necessary to build the spherical core preform for the desired core structure, as follows. The FEA model of a golf ball structure can be designed in a computer to achieve optimal performance properties and the data can be transferred to a CNC machine to build the composite golf components of dissimilar materials using precisely controlled dispensing nozzles.

A multi-axis computer controlled system will be used to control the spin of the in-construction core preform. The spherical preform building begins with a substantially spherical center (or somewhat rigid hollow shell), if polymer material, either cured or uncured state. Utilizing either or all of the following: vision, laser measurement and encoder controlled drive axes, the preform can be aligned to dispensing devices of the composite materials.

Some core preform building methods are (but not limited to):
1. Controlled application of fluid polymers in spots or strips progressively to fill a shell layer. Multiple dispense heads can be used for each individual adjoining polymer similar to ink jet printing, pen plotting or hot melt adhesive dispensing;
2. Wrapping with fibers or fiber reinforced polymer strands or tape forms. Continuous fibers or fiber based composites can be laid down as part of a shell layer and finishing the layer by applying adjoining regions of polymer materials;
3. Wrapping with preformed polymer tapes or strands, either cross-linked or not. Continuous lengths of polymers can be laid down as part of a shell layer and finishing the layer by applying adjoining regions of polymer materials either in preform state or in spot/strip application as in 1 above;
4. Materials may be added in small increments, e.g., less than 1 mm³, to form preforms;
5. Preformed shapes cross-linked or not and with or without a binding matrix can be placed by a robot, like brick laying, to form the spherical layer; and
6. Stereo lithograph technology can be applied including the usage of a 3D printer.

The core structure can be built with a single outer layer over a center form or multiple combinations of non-homogeneous layers and mixed with homogeneous layer built with the same methodology described above or utilizing current outer shell processes. Layers can be applied to a previously cross-linked mostly spherical shape or non-cross-linked in-construction preform. Layers or the inner center region can be mostly spherical multi-sided polygon like a geodesic sphere.

Circumferential molecular chain alignment of the applied polymer or dissimilar materials can be achieved through, but not limited to methods like: extrusion through a small die into either round bead or thin tape configuration, drawing an extruded profile longer than the original geometry, calendering the polymer through a thin nip.

Full sphere or hemispheres preforms can be built up also without use of a cavity. Hemispherical half shells can be built up with individual injectors (one injector for each material) used in the building of the composite core outer shell layer(s). In one embodiment, an outer layer material is injected directly into a hollow partial hemispherical cavity and this shell can either be heated and cross-linked within this cavity or transferred into a crosslinking cavity. In another embodiment, a half hemisphere form is built up then removed and assembled two half shell preforms over a substantially spherical center, the assembly will be transferred into a crosslinking mold to finish the core.

Hemispherical composite half shells can also be made up in the following way. By first making a hemispherical homogeneous material shell inside a cavity with retractable pins, then pulling the pins out of the shell material forming voids and later filling the voids with material of other desirable physical properties to form the composite shell preform and later assemble with a second half shell around a center and curing. Next, forming a homogeneous material half shell then “punching” holes to form voids and later filling the voids with material of other desirable physical properties to form the composite shell preform and later assemble around a center with a second half shell and curing.

The one or more heterogeneous layers and the preform are then formed into a golf ball component. The heterogeneous layers and the preform may be subjected to a compression or injection molding process to obtain solid spheres for the center or hemispherical shells for forming an intermediate layer. The polymer mixture may be subjected to a molding cycle in which heat and pressure are applied while the mixture is confined within a mold. The cavity shape depends on the portion of the golf ball being formed. Any other materials used in forming either the golf ball center or any portion of the core, in accordance with the invention, may be combined to form a golf ball by an injection molding process, which is also well-known to one of ordinary skill in the art.

Based upon information and belief, the said 1.510″ solid cores can be made into a 2-piece cover golf ball by either compression or injection molding of a thermoplastic cover materials like Surlyn® ionomers or other suitable thermoplastic polymers and their blends. Similar or slightly modified core formulations may be used to produce cores with varying diameters from 1.53″ to 1.60″.

Based upon information and belief, the said 1.510″ solid cores may be covered with a casing layer by either compression or injection molding of a thermoplastic cover materials like Surlyn® ionomers or other suitable thermoplastic polymers and their blends and converted into a 3-piece golf ball by casting a thermoset polyurethane or polyurea cover layer around the casing layer or by injection or compression molding a thermoplastic urethane or suitable thermoplastic cover material. It also should be noted that the filler materials listed in the Examples may also include barium sulfate (BaSO4) and other fillers.

The polyol is reacted with an isocyanate component to form the prepolymer. Suitable isocyanates include aliphatic, cycloaliphatic, aromatic aliphatic, derivatives thereof, and combinations thereof having two or more isocyanate (NCO) groups per molecule. The isocyanates may be organic, modified organic, organic polyisocyanate-terminated prepolymers, or a combination thereof. The isocyanate-containing reactable component may also include any isocyanate-functional monomer, dimer, trimer, or multimeric adduct thereof, prepolymer, quasiprepolymer, or combination thereof. Isocyanate-functional compounds may include monoisocyanates or polyisocyanates that include any isocyanate functionality of two or more.

Suitable isocyanate-containing components include diisocyanates having the general formula NCO—R—NCO, where R is preferably a cyclic or linear or branched hydrocarbon moiety containing from 1 to 20 carbon atoms. When multiple cyclic groups are present, linear and/or branched hydrocarbons containing from 1 to 10 carbon atoms can be present as spacers between the cyclic groups. In some cases, the cyclic group(s) may be substituted at the 2-, 3-, and/or 4-positions, respectively. Substituted groups may include, but are not limited to, halogens, primary, secondary, or tertiary hydrocarbon groups, or combinations thereof.

Non-limiting examples of particularly suitable unsaturated isocyanates, i.e., aromatic compounds, include 2,2′-, 2,4′-, and 4,4′-diphenylmethane diisocyanate (MDI); 3,3′-dimethyl-4,4′-biphenyl diisocyanate (TODD; toluene diisocyanate (TDI); polymeric MDI; carbodimidemodified liquid 4,4′-diphenylmethane diisocyanate; para-phenylene diisocyanate (PPDI); metaphenylene diisocyanate (MPDI); triphenylmethane-4,4′-, and triphenylmethane-4,4″triisocyanate; napthylene-I,5,-diisocyanate; 2,4′-, 4,4′-, and 2,2′-biphenyl diisocyanate; polyphenylene polymethylene polyisocyanate (PMDI) (also known as polymeric PMDI); and combinations thereof.

Non-limiting examples of particularly suitable saturated isocyanates include ethylene diisocyanate; propylene-I,2-diisocyanate; tetramethylene diisocyanate; tetramethylene-I,4-diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-I,12-diisocyanate; cyclobutane-I,3-diisocyanate; cyclohexane-I,2-diisocyanate; cyclohexane-I,3-diisocyanate; cyclohexane-I,4-diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); triisocyanate of HDI; triisocyanate of 2,2,4-trimethyl-1,6-hexane diisocyanate (TMDI); 4,4′dicyclohexylmethane diisocyanate (H12MDI); 2,4-hexahydrotoluene diisocyanate; 2,6-hexahydrotoluene diisocyanate; aromatic aliphatic isocyanate, such as 1,2-, 1,3-, and 1,4-xylene diisocyanate; meta-tetramethylxylene diisocyanate (m-TMXDI); para-tetramethylxylene diisocyanate (p-TMXDI); trimerized isocyanurate of any polyisocyanate, such as isocyanurate of toluene diisocyanate, trimer of diphenylmethane diisocyanate, trimer of tetramethylxylene diisocyanate, isocyanurate of hexamethylene diisocyanate, isocyanurate of isophorone diisocyanate, and mixtures thereof; dimerized uretdione of any polyisocyanate, such as uretdione of toluene diisocyanate, uretdione of hex am ethylene diisocyanate, and combinations thereof; modified polyisocyanate derived from the above isocyanates and polyisocyanates; and combinations thereof. In a particular embodiment, the isocyanate is MDI.

Any polyol available to one of ordinary skill in the art is suitable for use in the polyurethane prepolymer. Exemplary polyols include, but are not limited to, polyether polyols, polycaprolactone polyols, polyester polyols, polycarbonate polyols, and hydrocarbon polyols. The hydrocarbon chain of the polyol can have saturated or unsaturated bonds, or substituted or unsubstituted aromatic and cyclic groups.

Suitable polyether polyols include, but are not limited to, olytetramethylene ether glycol (PTMEG); copolymers ofpolytetramethylene ether glycol and 2-methyl-1,4-butane diol (PTGL); poly(oxyethylene) glycol; poly(oxypropylene) glycol; ethylene oxide capped (polyoxypropylene) glycol; poly(oxypropylene oxyethylene) glycol; and combinations thereof.

Suitable polycaprolactone polyols include, but are not limited to, diethylene glycol initiated polycaprolactone; propylene glycol initiated polycaprolactone; 1,4-butanediol initiated polycaprolactone; 1,6-hexanediol initiated polycaprolactone; trimethylol propane initiated polycaprolactone; neopentyl glycol initiated polycaprolactone; polytetramethylene ether glycol initiated polycaprolactone; ethylene glycol initiated polycaprolactone; dipropylene glycol initiated polycaprolactone; and combinations thereof.

Suitable polyester polyols include, but are not limited to, polyethylene adipate glycol; polyethylene propylene adipate glycol; polybutylene adipate glycol; polyethylene butylene adipate glycol; polyhexamethylene adipate glycol; polyhexamethylene butylene adipate glycol; o-phthalate-I,6-hexanediol polyester polyol; polyethylene terephthalate polyester polyols; and combinations thereof.

Suitable polycarbonate polyols include, but are not limited to, poly(phthalate carbonate) glycol, poly(hexamethylene carbonate) glycol, polycarbonate polyols containing bisphenol A, and combinations thereof.

Suitable hydrocarbon polyols include, but are not limited to, hydroxy-terminated liquid isoprene rubber (UR), hydroxy-terminated polybutadiene polyol, hydroxy-telminated polyolefin polyols, hydroxy-terminated hydrocarbon polyols, and combinations thereof.

Other polyols that may be used to form the prepolymer include, but are not limited to, glycerols; castor oil and its derivatives; Polytail™ Hand Polytail™ HA polyhydroxy polyolefin oligomers, commercially available from Mitsubishi Chemical; acrylic polyols; acid functionalized polyols based on a carboxylic, sulfonic, or phosphoric acid group; dimer alcohols converted from the saturated dimerized fatty acid; and combinations thereof.

By using polyols based on a hydrophobic backbone, the polyurethane composition may be more water resistant than those using polyols without a hydrophobic backbone. Non-limiting examples of polyols based on a hydrophobic backbone include hydrocarbon polyols, hydroxyterminated polybutadiene polyols, polyethers, polycaprolactones, and polyesters. In a particular embodiment, the polyol is PTMEG.

The polyurethane prepolymer is reacted with a curing agent. The curing agent may consist of a single curing agent or comprise a combination of two or more curing agents, and optionally includes a freezing point depressing agent. Suitable curing agents include, but are not limited to, hydroxy-terminated curing agents, amine-terminated curing agents, and combinations thereof. The curing agent may be saturated or unsaturated.

Non-limiting examples of suitable curatives include 1,4-butanediol; 1,3-butanediol; 1,2-butanediol; 2,3-butanediol; 2,3-dimethyl-2,3-butanediol; propylene glycol, dipropylene glycol; polypropylene glycol; 2-methyl-I,3-propanediol; 2-methyl-I,4-butanediol; ethylene glycol; diethylene glycol; polyethylene glycol; resorcinol-di(beta-hydroxyethyl)ether and its derivatives; hydroquinone-di(beta-hydroxyethyl)ether and derivatives thereof; 2-propanol-I,1′phenylaminobis; trimethylolpropane; 4,4′-methylenebis(2-chloroaniline); 3,5-dimethylthio-2,4-toluenediamine; 3,5-dimethylthio-2,6-toluenediamine; 4,4′-methylenebis(2-ethylaniline); 4,4′bis-(sec-butylamino)-diphenylmethane; 1,3-bis-(2-hydroxyethoxy)benzene; 1,3-bis-[2-(2-hydroxyethoxy)ethoxy]benzene; 1,3-bis-{2-[2-(2-hydroxyethoxy)ethoxy]ethoxy}benzene; 1,4-bis-(sec-butylamino)benzene; 1,2-bis-(sec-butylamino)benzene; 3,5-diethyltoluene-2,4-diamine; 3,5-diethyltoluene-2,6-diamine; tetra-(2-hydroxypropyl)-ethylenediamine; N,N′-dialkyldiamino diphenyl methane; trimethyleneglycol-di-p-aminobenzoate; polytetramethyleneoxide-di-paminobenzoate; 4,4′-methylene bis-(3-chloro-2,6-diethylaniline); 1,4-cyclohexyldimethylol; 2-methylpentamethylene diamine; isomers and mixtures of diaminocyclohexane; isomers and mixtures of cyclohexane bis(methylamine); polytetramethylene ether glycol; isomers and mixtures of cyclohexyldimethylol; triisopropanolamine; diethylene triamine; triethylene tetramine; tetraethylene pentamine; propylene diamine; dipropylene triamine; 1,3-diaminopropane; dimethylamino propylamine; diethylamino propyl amine; diethylene glycol bis(aminopropyl)ether; imido-bis-(propylamine); monoethanolamine; diethanolamine; triethanolamine; mono isopropanol amine; diisopropanolamine; isophoronediamine; N,N′diisopropyl-isophoronediamine; polyoxypropylene diamine; propylene oxide-based triamine; 3,3′-dimethyl-4,4′-diaminocyclohexylmethane; 1,5-pentanediol; 1,6-hexanediol; glycerol; 1,3-bis-(2-hydroxyethoxy)cyclohexane; 1,3-bis-[2-(2-hydroxyethoxy)ethoxy cyclohexane; 1,3-bis-{2-[2-(2-hydroxyethoxy)ethoxy]ethoxy}cyclohexane; N,N,N′,N′-tetra-(2-hydroxypropylethylene)diamine; ethylene diamine; hexamethylene diamine; 1-methyl-2,6-cyclohexyl diamine; 2,2,4- and 2,4,4-trimethyl-1,6-hexanediamine; 4,4′-bis-(sec-butylamino)-dicyclohexylmethane and derivatives thereof; 1,4-bis-(sec-butylamino)-cyclohexane; 1,2-bis-(sec-butylamino)-cyclohexane; 4,4′-dicyclohexylmethane diamine; and combinations thereof.

In a particular embodiment, the curing agent is a dimethylthiotoluenediamine, e.g., Ethacure® 300 curative comprising dimethylthiotoluenediamine with a minor amount of monomethylthiotoluenediamine, commercially available from Albemarle Corporation.

The curing agent optionally comprises a freezing point depressing agent so that the freezing point of the blend is less than its normal freezing point temperature. The freezing point depressing agent is preferably compatible with the curing agent. For example, hydroxytenninated curing agents, such as 1,4-butanediol, may be modified with a hydroxy-terminated freezing point depressing agent or a mixture of hydroxy-terminated freezing point depression agents. Examples of hydroxy-terminated freezing point depressing agents include, but are not limited to, 1,3-propanediol, 2-methyl-1,3-propanediol, 2-methyl-1,4-butanediol, 1,2-butanediol, 1,3-butanediol, ethylene glycol, diethylene glycol, 1,5-pentanediol, polytetramethylene glycol, propylene glycol, dipropylene glycol, and combinations thereof. Similarly, amine-terminated curing agents, such as hexamethylene diamine, may be modified with an amine-terminated freezing point depressing agent or a mixture of amine-terminated freezing point depressing agents. Examples of amine-terminated freezing point depressing agents include, but are not limited to, ethylene diamine, 1,3-diaminopropane, dimethyl amino propylamine, tetraethylene pentamine, 1,2-propylenediamine, diethylaminopropylamine, 2,2,4-trimethyl-1,6-hexanediamine, 2,4,4-trimethyl-1,6-hexanediamine, and combinations thereof. The freezing point depressing agent is preferably added in an amount sufficient to reduce the freezing point of the curing agent by a suitable amount to prevent loss of pigment dispersion, but not affect the physical properties of the golfball. Freezing point depressing agents are further disclosed, for example, in U.S. Pat. No. 7,888,449 to Wu, the entire disclosure of which is hereby incorporated herein by reference.

Suitable isocyanates, polyols, and curing agents are further disclosed, for example, in U.S. Patent Application Publication No. 2012/0015758 to Michalewich; U.S. Patent Application Publication No. 2012/0100935 to Michalewich; U.S. Pat. No. 6,528,578 to Wu; U.S. Pat. No. 6,506,851 to Wu; U.S. Pat. No. 7,148,278 to Bulpett; and U.S. patent application Ser. No. 13/534,264 to Michalewich; the entire disclosures of which are hereby incorporated herein by reference.

Golf ball constructions are further provided with customized regions and or customized cover layer region to enhance golfer putting. In one embodiment, the one or more cover performance regions are marked with one or more of the following to indicate hard material regions and soft material regions: different colors, indicia, and dimple sizes. In one embodiment, the regions would be identifiable by markings or easily distinguishable dimple pattern difference from the rest of the ball (substantially different dimple size or shape) or combination of both. In one embodiment, the one or more heterogeneous cover performance regions are marked. In another embodiment, one or more homogeneous performance regions are marked. In a further embodiment, a combination of heterogeneous and homogeneous performance regions, in combinations thereof, are marked.

Methods of manufacturing golf balls with performance regions, as part of non-homogeneous covers or outer layers and ball construction with these enhanced regions engineered for customized performance in putting (or any other club shots that would benefit from this invention). Customized regions of hard and soft materials would meet golfers needs for feel, spin, sound, etc. for the shot he has aligned the ball for.

This method of making a golf ball offers the golfer performance improvement and allow different ball characteristics that can be brought into play by the golfer on demand in shots they are able to align the ball. Golfers have shown in the past their preference to align identifiable regions of different dimple geometry to the club face on certain shots. This invention allows for more defined and more customized regions for specific club shots better meeting golfer's preferences. This invention not only covers dimple geometries but also physical properties of the cover and/or outer layers that will be customized to meet a golfer's preference when setting the ball up for certain shots.

In operation, the mechanics in the impact zone of the golf club hitting the golf ball is dramatically different between different clubs, most dramatically between driving and putting. Golf balls that are non-homogeneous in construction and physical properties of the materials making up the cover and outer layers and with defined regions of the varying physical properties would have different response to the club impact depending on the physical makeup of the region it impacted.

Physical differences of these performance regions would have to be subtle enough and the regions plurally and symmetrically located around the ball so that they would not affect impact symmetry in non-alignable shots. For example, slits, cutouts, or frets are filled with zero modulus, soft materials without changes to aerodynamics of the golf ball. In another embodiment, the multi-modulus cover is aligned within the features of the core or intermediate layers to reduce impact on aerodynamics of the golf ball.

A non-homogeneous dimple design or exaggerated frets may be designed for enhanced putter impact would have smaller diameter dimples to minimize a non-perpendicular reaction vector of the ball from the club face. This region would make up small enough areas on the cover so that other shots wouldn't be impacted by the non-homogeneous structure at the transition to the rest of the golf ball cover.

Non-homogeneous physical property regions would be in the cover and/or outer layers of the golf ball and would be manufactured by controlled application of the materials within the desired regions. Regions could be built up with methods above for outer layers of the golf ball core.

Subsequent cover molding with identifying geometry or later markings will have to be aligned with the performance region with a variety of computer controlled manufacturing methods and or vision motion control application with the performance region identifiable through a color difference to its surrounding material.

Golf balls with non-homogeneous regions in the cover can be manufactured by numerous methods including but not limited to:

1. A multi-step cover injection molding or casting operation utilizing a variety of molding techniques to knit materials together molded at different times, like a post cure with ball in cavity to generate very high cavity pressure; and

2. Building the multi-regioned cover preform in either individual shells to be later assembled later and subsequently compression molded to finish the dimples; or building the non-homogeneous cover material layer directly on the core and then compression molding to finish the dimples.

Golf balls of the invention comprising two or more dissimilar materials may have a variety of further configurations. The golf balls can include one-piece, two-piece, multi-layer, and wound golf balls having a variety of core structures, intermediate layers, covers, and coatings.

Golf ball cores of the invention may comprise a single, unitary layer, comprising the entire core from the center of the core to its outer periphery. Also, the core maybe a single, double, triple or more layer cores. Alternatively, the cores may comprise or consist of a center surrounded by at least one outer core layer. The center, innermost portion of such multi-layer cores is most often solid, but may be hollow or liquid-, gel-, gas-filled, or other types of cores. The outer core layer may be solid, or it may be a wound layer formed of a tensioned elastomeric or non-elastomeric material.

In another embodiment, the golf ball further the golf ball further comprises one or more layers. Optionally, additional intermediate layers may be disposed between the core and cover. In one embodiment of the invention, golf ball includes a core and a cover layer. In another embodiment, the golf ball includes a core, an intermediate layer, and a cover layer. An intermediate layer may be formed from a thermoplastic or thermoset material. In one embodiment, the intermediate layer has a thickness of 0.010 to 0.030 inches, preferably 0.015 to 0.025 inches, and more preferably 0.015 to 0.020 inches. It should be noted that two or more dissimilar materials may be used in any of the layers or components of the golf ball.

The golf balls of the invention can also include one or more other additives as desired in order to produce a golf ball with specific characteristics or properties. Suitable additives include, but are not limited to, chemical blowing and foaming agents, optical brighteners, coloring agents, fluorescent agents, whitening agents, UV absorbers, light stabilizers, defoaming agents, processing aids, mica, talc, nano-fillers, antioxidants, stabilizers, softening agents, fragrance components, plasticizers, impact modifiers, TiO2, acid copolymer wax, surfactants, and fillers, such as zinc oxide, tin oxide, barium sulfate, zinc sulfate, calcium oxide, calcium carbonate, zinc carbonate, barium carbonate, clay, tungsten, tungsten carbide, silica, lead silicate, regrind (recycled material), and mixtures thereof. Suitable additives are more fully described in, for example, U.S. Pat. No. 7,041,721, the entire disclosure of which is hereby incorporated herein by reference. Other optional additives can include fibers, flakes, particulates, microspheres, pre-expanded beads of glass, ceramic, metal or polymer, and the like which may be optionally foamed.

The core of the invention may have an Atti compression of less than about 80, more preferably, between about 40 and about 80, and most preferably, between about 50 and about 70. In an alternative, low compression embodiment, the core has a compression less than about 20, more preferably less than about 10, and most preferably, 0. The overall outer diameter (“OD”) of the core is less than about 1.610 inches, preferably, no greater than 1.590 inches, more preferably between about 1.540 inches and about 1.580 inches, and most preferably between about 1.50 inches to about 1.570 inches. The OD of the casing of the golf balls of the invention is preferably between 1.580 inches and about 1.640 inches, more preferably between about 1.590 inches to about 1.630 inches, and most preferably between about 1.600 inches to about 1.630 inches.

In a further embodiment, the cover of the golf balls may have a thickness of at least about 0.03 inches, preferably 0.03 to 0.125 inches, and more preferably from about 0.05 to 0.1 in ches. In another embodiment, one of the inner and outer cover layers may have a thickness of less than about 0.05 inches. The golf balls also may have at least about 60 percent dimple coverage, preferably at least about 80 percent dimple coverage, of the surface area of the cover.

The present golf ball can have an overall diameter of any size. Although the United States Golf Association (“USGA”) specifications limit the minimum size of a competition golf ball to 1.680 inches. There is no specification as to the maximum diameter. Golf balls of any size, however, can be used for recreational play. The preferred diameter of the present golf balls is from about 1.680 inches to about 1.800 inches. The more preferred diameter is from about 1.680 inches to about 1.760 inches. The most preferred diameter is about 1.680 inches to about 1.740 inches.

In addition, the methods for making a golf ball above may be incorporated into other golf equipment, golf clubs, putters, irons, and woods, and in golf shoes and components thereof.

As used herein, the term “about,” used in connection with one or more numbers or numerical ranges, should be understood to refer to all such numbers, including all numbers in a range.

Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

While it is apparent that the illustrative embodiments of the invention disclosed herein fulfill the objective stated above, it is appreciated that numerous modifications and other embodiments may be devised by those skilled in the art. Therefore, it will be understood that the appended claims are intended to cover all such modifications and embodiments, which would come within the spirit and scope of the invention.

What is claimed is:

1. A method of making a golf ball, comprising:
providing at least two or more dissimilar materials;
applying the at least two or more dissimilar materials onto a substrate to provide one or more heterogeneous preforms; and
forming the one or more heterogeneous preforms into a golf ball component.

2. The method of claim 1, wherein the substrate is cavities for receipt of the two or more dissimilar materials and the dissimilar materials are injected into the cavities using a plurality of injection heads to form the one or more heterogeneous preforms.

3. The method of claim 1, wherein the two or more dissimilar materials comprise polybutadiene and zinc diacrylate adjusted to provide soft and hard areas within the heterogeneous preform and the preform is cured into a golf ball core or golf ball core center.

4. The method of claim 3, wherein the zinc diacrylate is present in an amount between 10-25 parts per hundred of polybutadiene to provide a softer area within the one or more heterogeneous preform and in an amount between 26-40 parts per hundred of polybutadiene to provide a harder area within the one or more heterogeneous preform.

5. The method of claim 1, wherein the two or more dissimilar materials comprises two or more thermoplastic polymers with dissimilar hardness adjacent to one another to provide soft and hard areas within the heterogeneous preform.

6. The method of claim 1, wherein the two or more dissimilar materials comprises thermoplastic, thermoset materials, or combinations thereof having carboxylic acid less than 12% to provide a softer area within the one or more heterogeneous preforms.

7. The method of claim 1, wherein the two or more dissimilar materials comprises thermoplastic, thermoset materials, or combinations thereof having carboxylic acid greater than 19% to provide a harder area within the one or more heterogeneous preforms.

8. The method of claim 1, wherein the two or more dissimilar materials comprises Surlyn® 7940 in the range of 30-50%, Surlyn® 8940 in the range of 30-50%, and 10-40% of Surlyn® 8320 or Fusabond® to provide a softer area within the one or more heterogeneous preforms.

9. The method of claim 1, wherein the two or more dissimilar materials comprises Surlyn® 8150 in the range of 30-50% and Surlyn® 9150 in the range of 30-50% to provide a harder area within the one or more heterogeneous preforms.

10. The method of claim 1, wherein the two or more dissimilar materials are applied onto a substrate in a form selected from a group consisting: a fluid state, layers, shapes, and combinations thereof.

11. The method of claim 1, wherein the applying of at least two or more materials uses stereolithography.

12. The method of claim 1, wherein the applying of at least two or more dissimilar materials uses a computer-controlled robot.

13. The method of claim 1, wherein the applying of at least two or more dissimilar materials uses a plurality of controlled dispensing nozzles.

14. The method of claim 1, wherein the applying of at least two or more dissimilar materials uses a plurality of 3-D printer nozzles.

15. A method of making a golf ball, comprising:
providing at least two or more dissimilar materials;
disposing the dissimilar materials into cavities to form heterogeneous preform shells;
forming the heterogeneous perform shells over a golf ball core to form a heterogeneous intermediate layer or cover.

16. The method of claim 10, wherein the two or more dissimilar materials comprise thermoplastic materials having flexural moduli that differ by at least 20,000 psi.

17. The method of claim 10, wherein the two or more dissimilar materials comprise thermoplastic materials having material hardnesses that differ by at least 5 Shore D.

18. A method of making a golf ball, comprising:
providing at least two or more dissimilar materials;
applying the two or more dissimilar materials into one or more cover layers to provide one or more cover heterogeneous performance regions;
forming the one or more cover heterogeneous performance regions into the golf ball component.

19. The method of claim 17, wherein the one or more cover layers defines cavities for receipt of the two or more dissimilar materials and the dissimilar materials are injected into the cavities using a plurality of injection heads to form the one or more cover heterogeneous performance regions.

20. The method of claim 17, wherein the one or more cover performance regions are marked with one or more of the following to indicate harder material regions and softer material regions: different colors, indicia, and dimple sizes.
